(19) United States
(12) Patent Application Publication
(10) Pub. No.: US 2012/0318783 A1
(43) Pub. Date: Dec. 20, 2012

(54) WARM-UP CONTROL DEVICE FOR VEHICLE

(75) Inventor: Makoto KAMACHI, Okazaki-shi (JP)

(73) Assignee: MITSUBISHI JIDOSHA KOGYO KABUSHIKI KAISHA, Tokyo (JP)

(21) Appl. No.: 13/423,517

(22) Filed: Mar. 19, 2012

(30) Foreign Application Priority Data
Jun. 14, 2011 (JP) 2011-132272

(51) Int. Cl. H05B 1/02

(52) U.S. Cl. 219/497

(57) ABSTRACT

A warm-up control device for a vehicle includes a battery supplying electricity to a motor that drives a vehicle and can be charged with a current supplied from the exterior of the vehicle, and a heater generating heat that warms up the vehicle by the above current. The warm-up control device further includes a temperature acquisition unit acquiring a temperature of the battery, and a current distribution control unit increasing a heater supply current supplied to the heater as the temperature of the battery decreases. This can effectively utilize energy from an external power source for the charging and warming-up, thus improving the energy saving performance.

### CROSS-REFERENCE TO THE RELATED APPLICATION

This application incorporates by references the subject matter of Application No. 2011-132272 filed in Japan on Jun. 14, 2011 on which a priority claim is based under 35 U.S.C. §119(a).

### FIELD

The present invention relates to a warm-up control device for a vehicle equipped with a battery that can be charged from an external power source.

### BACKGROUND

To date, electric or hybrid vehicles have been developed which is equipped with a battery for running that is charged with electricity supplied from an external power source. Such a vehicle can be readily charged with electricity by connecting the on-board charger and an outlet of an external power source through a charging cable. It has been proposed that external power sources for charging are available from, for example, general household outlets and charging stations that correspond to gas stations for gas vehicles.

It is known that the performance of batteries varies with temperatures of the usage environment. For example, the electricity produced by a battery having a temperature below the freezing point is lower than that having an ordinary temperature. This is also applied to the charging property. A high charging current thus cannot be obtained at a low battery temperature. Accordingly, various techniques have been proposed, in which an electric heater for warming up the battery is provided in a vehicle and the electric heater works in accordance with the temperature of the battery.

For example, Japanese Laid-open Patent Application No. 2009-224256 discloses a battery warm-up system that warms up a battery by driving an air-conditioning electric heater, while the battery is being charged from an external power source. This technique feeds a current to the electric heater in accordance with the temperature of the battery, and causes cooling water that has been heated by the electric heater to pass through a heat exchanger placed adjacent to the battery, thereby increasing the temperature of the battery.

Unfortunately, known battery warm-up systems do not adequately control the amount of the heat energy generated by the warm-up operation. This makes it difficult to utilize the electricity supplied from an external power source efficiently. For example, the technique disclosed in the above-mentioned patent application generates a constant amount of the heat by allowing the electric heater to work irrespective of the temperature, as long as the temperature of the battery is equal to or less than a predetermined temperature. Accordingly, this technique fails to exhibit the appropriate warm-up efficiency in extremely low-temperature environments, for example, a battery temperature much lower than the predetermined temperature. As a result, charging or warm-up period may be prolonged. For this reason, known techniques cannot sufficiently improve the energy saving performance.

### SUMMARY

### Technical Problems

An object of the present invention, which has been conceived in consideration of the above-mentioned disadvantages, is to provide a warm-up control device for a vehicle which improves energy saving performance by efficiently utilizing energy generated in relation to charges from an external power source and warm-up operations.

Note that in addition to this object, features and advantageous effects which configurations described in embodiments of the present invention as will be described below introduce and which known techniques fail to produce are included in other objects of the present invention.

### Solution to Problems

(1) A warm-up control device for a vehicle disclosed herein includes: a battery supplying electricity to a motor that drives a vehicle, the battery being capable of being charged with a current supplied from an exterior of the vehicle; and a heater generating heat by the current supplied from the exterior of the vehicle, the heat warming up the vehicle. Furthermore, the warm-up control device includes a temperature acquisition unit acquiring a temperature of the battery; and a current distribution control unit distributing the current supplied from the exterior of the vehicle to the battery and the heater, wherein the current distribution control unit increases a heater supply current supplied to the heater as the temperature of the battery decreases.

The heat generated by the heater is used to warm up the vehicle, in particular, to increase the temperature of a power plant of the vehicle. For example, this heat can be used to increase the temperature of the battery or an electric motor running on the electricity from the battery. In addition, this heat may be used to increase the temperature of, for example, the engine, cooling water for the engine, and engine oil, if the vehicle is equipped with an engine.

(2) Preferably, the current distribution control unit sets a battery supply current supplied to the battery to be equal to or less than a battery chargeable current determined on the basis of the temperature property of the battery.
(3) Preferably, the warm-up control device further includes a current detecting unit that detects an external current supplied from the exterior of the vehicle, and the current distribution control unit sets the battery supply current supplied to the battery to be equal to or less than the external current. In this case, preferably, the current distribution control unit sets the maximum heater supply current to a difference between the battery supply current and the external current. Note that the current distribution control unit preferably decreases the battery supply current as the temperature of the battery decreases.
(4) Preferably, the current distribution control unit sets the battery supply current supplied to the battery to be equal to or lower than an upper limit current that is smaller than the external current.
(5) Preferably, the current distribution control unit sets a value obtained by subtracting a minimal warm-up current from the external current to the upper limit current, the minimal warm-up current corresponding to the minimum heater supply current.
(6) Preferably, the vehicle is a hybrid vehicle equipped with the motor and an engine, the heater includes a first heater increasing a temperature of the battery, and a second heater increasing the temperature of the engine. In addition, preferably, the current distribution control unit regulates respective currents supplied to the first heater and the second heater, on the basis of the temperature of the battery.
(7) Preferably, the warm-up control device further includes: a relay disposed on an electricity supply line connecting the vehicle and an external current source that supplies the current to the vehicle; and a relay control unit establishing connection of the relay during a charging mode of the battery or a working mode of the heater, and breaking the connection of the relay during a non-charging mode of the battery and a non-working mode of the heater.
(8) Preferably, the warm-up control device further includes: signal lines connected to the relay control unit and carrying a current signal indicating a current obtained from the electricity supplied from the exterior of the vehicle; a charge permission switch connected to the signal lines and providing, to the relay control unit, a signal indicating the charge of the battery, in accordance with an operation of the charge permission switch; and a warm-up heater switch connected to the signal lines in parallel to the charge permission switch and providing, to the relay control unit, a signal indicating the supply of the electricity to the heater.

### Advantageous Effects

The warm-up control device for a vehicle disclosed herein can increase a current supplied to the heater as the battery temperature decreases, in order to overcome a disadvantageous property of the battery, that is, a low charging efficiency at a low battery temperature. This can effectively utilize a current supplied from the exterior of a vehicle and shorten the warm-up time. Moreover, the warm-up control device causes the heater to generate a larger amount of heat as the battery temperature decreases, thus improving the chargeable capacity of the battery adequately and shortening the charge time.

### BRIEF DESCRIPTION OF DRAWINGS

The nature of this invention, as well as other objects and advantages thereof, will be explained in the following with reference to the accompanying drawings, in which like reference characters designate the same or similar parts throughout the figures and wherein:

FIG. 1 is a side view illustrating a vehicle including a warm-up control device for a vehicle according to an embodiment of the present invention.

FIG. 2 is a schematic view illustrating a block diagram and circuit of the warm-up control device shown in FIG. 1.

FIG. 3 is a graph for explaining a control process performed by the warm-up control device shown in FIG. 1.

FIG. 4 is a flowchart exemplifying a control process performed by a pilot controller shown in FIG. 2.

FIG. 5 is a flowchart exemplifying a control process performed by an on-board controller shown in FIG. 2.

FIGS. 6A to 6C are graphs for explaining a control process performed by a warm-up control device according to a variation of the embodiment.

### DESCRIPTION OF EMBODIMENTS

A warm-up control device according to an embodiment of the present invention will be described, with reference to the accompanying drawings. Note that the following embodiment is merely an example, and does not intend to exclude various variations and applications of techniques that are not described explicitly therein. In addition, individual configurations described in the embodiment may be selectively employed as necessary, be combined as appropriate, or be varied and implemented in various ways without departing from the spirits of the embodiment.

### 1. DEVICE CONFIGURATION

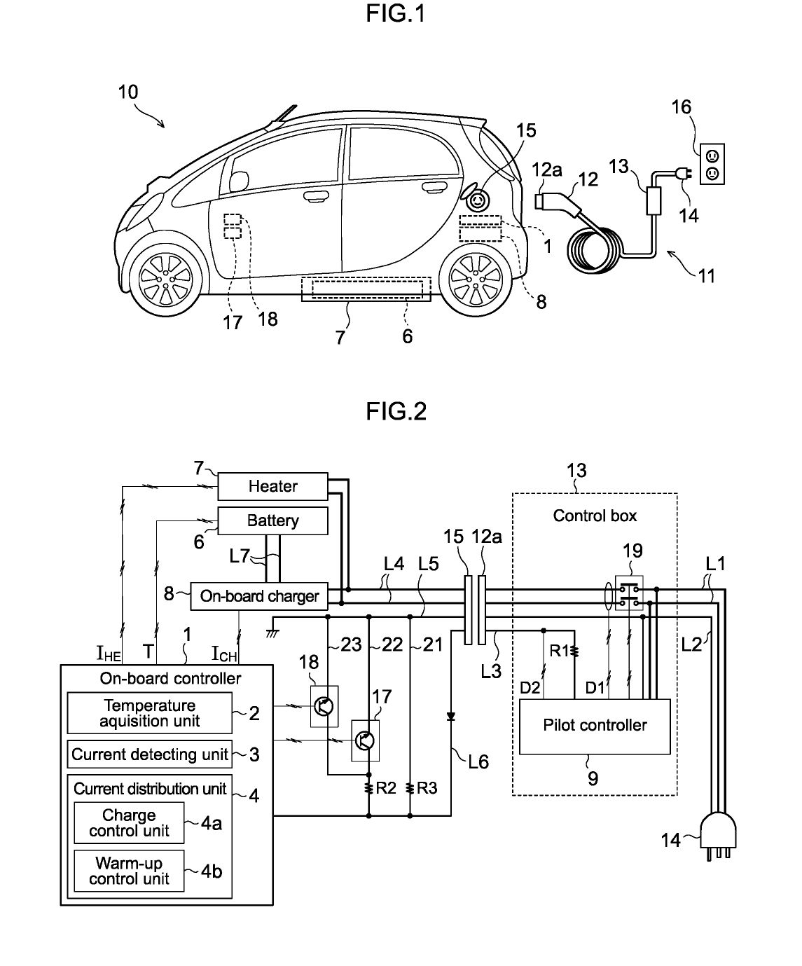

A warm-up control device for a vehicle according to this embodiment is installed in a vehicle 10, as shown in FIG. 1. This vehicle 10 is an electric vehicle that runs on electricity stored in a battery 6. This battery 6 is a storage device that can be charged with electricity regenerated during running, and electricity supplied from an external source at any given time.

The vehicle 10 is provided therein with an on-board controller 1 and an on-board charger 8 for charging the battery 6 from an external power source. The on-board charger 8 is a battery charger for converting an AC current supplied from an external power source into a DC current, and charging the battery 6 with this DC current. Note that this AC/DC conversion is unnecessary if an external DC power source is used. An inlet 15 (electricity drawing port) is provided on one side of the vehicle 10 for connecting the vehicle 10 and a charging cable 11 so that the battery 6 is charged from an external power source.

A heater 7 is provided near the battery 6. The heater 7 generates heat for warming up the vehicle 10 by current supplied from the battery 6 and an external power source. Herein, the term “heat for warming up” refers to general heat for warming up a power plant (power device) upon starting in the cold state, and this heat is used for increasing the temperature of, for example, the battery 6 or an electric motor for running. In addition, the heat may also be used for warming, for example, the engine, the engine oil, and the engine cooling water, if the vehicle 10 is a plug-in hybrid vehicle equipped with another engine in addition to the electric motor. This embodiment exemplifies the use of the heater 7 to increase the temperature of the battery 6.

As shown in FIG. 1, an end of the charging cable 11 is provided with a charging gun 12 which is provided with, at the top thereof, a connector 12a to be connected to the inlet 15 of the vehicle 10. The other end of the charging cable 11 is provided with a plug 14 to be connected to, for example, a household electrical outlet 16. This electrical outlet 16 is connected to an external power source (commercial power source) through electrical wiring (not shown). Note that this embodiment deals with a case where the external power source is a single-phase AC power source (or a single-phase three wire 100 or 200 VAC power source).

A control box 13 that houses a pilot controller 9 and a relay 19 is disposed at a midway point of an electricity supply route from the plug 14 to the charging gun 12 on the charging cable 11. The relay 19 is an electric relay, and the connection thereof is controlled by a pilot controller 9 (relay control unit). In addition, the relay 19 switches between a connecting state where a current is supplied from the external power source to the vehicle 10, and a disconnecting state where the current supply is interrupted.

A charge permission switch 17 and a warm-up heater switch 18 are arranged at any given locations in the vehicle 10. The charge permission switch 17 is turned on when the battery 6 is charged from the external power source, and turned off otherwise. Furthermore, the warm-up heater switch 18 is a switch that is turned on when the vehicle 10 is warmed up, and turned off otherwise.

Each of the charge permission switch 17 and the warm-up heater switch 18 may switch between ON and OFF of the connection thereof through user's manual operation, or automatically in accordance with the control of the on-board controller 1 under a predetermined condition. The charge permission switch 17 and the warm-up heater switch 18, which are employed in this embodiment, can switch between ON and OFF through a manual operation, or automatically in accordance with the control of the on-board controller 1 when a predetermined condition is established.

### 2. CIRCUIT CONFIGURATION

### [2-1. Cable]

As shown in FIG. 2, two power source lines L1 and L1 and an earth line L2 connected to the earth are routed between the plug 14 and the control box 13 on the charging cable 11. In addition to these power source lines L1 and L1 and earth line L2, a signal line L3 is routed between the control box 13 and the connector 12a of the charging gun 12. This signal line L3 mediates exchange of information between the on-board controller 1 and the pilot controller 9.

The relay 19 is provided for both the power source lines L1 and L1 in the control box 13. That is, the relay 19 lies astride both power source lines L1 and L1. The pilot controller 9 is connected to power receiving lines which are branched from the respective power source lines L1 and L1 between the plug 14 and the relay 19. The pilot controller 9 is activated immediately after the plug 14 is connected to the external power source. Furthermore, in the pilot controller 9, a leak detecting circuit D1 is provided for detecting the electrical leakage of the power source lines L1 and L1 between the connector 12a and the relay 19. This pilot controller 9 transmits, to the vehicle 10 through the signal line L3, information on current available from an external power source (or a duty signal).

The signal line L3 is provided with a resistance element R1 and a signal voltage detecting line D2. This signal voltage detecting line D2 is branched from the signal line L3 between the connector 12a and the resistance element R1. The signal voltage detecting line D2 detects a voltage at a point between the connector 12a and the resistance element R1, and carries the detected voltage to the pilot controller 9, as a signal voltage. Note that the signal voltage detected by the signal voltage detecting line D2 varies with the resistance value of a signal line L6 in the vehicle 10 connected to the signal line L3. Accordingly, the pilot controller 9 monitors this signal voltage, in order to determine the connecting state of the connector 12a and the operating states of the switches in the vehicle 10.

### [2-2. Vehicle]

Power source lines L4 and L4, an earth line L5, and the signal line L6 are routed corresponding to the power source lines L1 and L1, the earth line L2, and the signal line L3, respectively, from the connector 12a in the vehicle 10. As shown in FIG. 2, the heater 7 and the on-board charger 8 are connected to the power source lines L4 and L4 in parallel with each other. In addition, the battery 6 is connected to the on-board charger 8 through charging lines L7 and L7. The on-board controller 1 controls the amounts of the electricity with which the on-board charger 8 charges the battery 6 and which the heater 7 converts into heat.

A rectifier is disposed on the signal line L6, for allowing a current to flow only from the inlet 15 to the on-board controller 1. In addition, the signal line L6 is connected to the on-board controller 1 at an end remote from the inlet 15. The on-board controller 1 can detect the information on the current available from the external power source which is carried from the pilot controller 9, on the power source lines L1 and L1. Then, the on-board controller 1 controls the heater 7 and the on-board charger 8, on the basis of the detected information.

First to third resistance circuits 21 to 23 are provided between the earth line L5 and the signal line L6 for connecting them in a ladder-like structure. Through these resistance circuits 21 to 23, the on-board controller 1 and the pilot controller 9 detects, for example, the connecting state of the connector 12a and the inlet 15, and the operating states of the charge permission switch 17 and the warm-up heater switch 18. Note that FIG. 2 depicts an example in which two resistance elements R2 and R3 are arranged in the electric circuit.

The first resistance circuit 21 consists of the resistance element R3. Once the connector 12a and the inlet 15 are connected to each other, the signal line L3 constitutes a closed circuit together with the earth lines L2 and L5. As a result, a predetermined voltage potential corresponding to the total resistance of the resistance elements R1 and R2 is generated on the signal voltage detecting line D2.

The second resistance circuit 22 consists of the resistance element R2 and the charge permission switch 17 therein. When the charge permission switch 17 is turned on, a predetermined voltage potential corresponding to the total resistance of the resistance elements R1, R2 and R3 is generated on the signal voltage detecting line D2. The pilot controller 9 determines whether the charge permission switch 17 is turned on or off, on the basis of the signal voltage on the signal voltage detecting line D2. Since this signal voltage is also provided to the on-board controller 1, the on-board controller 1 can also determine the connecting state of the charge permission switch 17.

The third resistance circuit 23 consists of the warm-up heater switch 18 on a circuit branched from the second resistance circuit 22 at a node between the resistance element R2 and the charge permission switch 17. When at least one of the charge permission switch 17 and the warm-up heater switch 18 is turned on, a predetermined voltage potential corresponding to the total resistance of the resistance elements R1, R2 and R3 is generated on the signal voltage detecting line D2. The pilot controller 9 determines the operating states of the charge permission switch 17 and the warm-up heater switch 18, on the basis of the signal voltage on the signal voltage detecting line D2.

When controlling the relay 19, the pilot controller 9 does not need to distinguish the respective operating states of the charge permission switch 17 and the warm-up heater switch 18. However, the pilot controller 9 may be provided with, for example, a detection circuit (not shown) for distinguishing these operating states. Similarly, the on-board controller 1 may also monitor the operating states of the charge permission switch 17 and the warm-up heater switch 18 with a detection circuit (not shown) independently.

### 3. CONTROL CONFIGURATION

### [3-1. Outline of Control]

Each of the above-mentioned on-board controller 1 and pilot controller 9 is an LSI (large scale integration) device or an embedded electrical device formed by integrating, for example, a known microprocessor, ROM (read only memory) and RAM (random access memory). Both the on-board controller 1 and the pilot controller 9 control charge and warm-up over the vehicle 10.

The pilot controller 9 (relay control unit) switches between the connection and disconnection of the relay 19, and carries, to the on-board controller 1, the information on the current available from the external power source. An example of a condition in which the connection of the relay 19 is established is that at least one of the charge permission switch 17 and the warm-up heater switch 18 is turned on while the charging gun 12 is connected to the vehicle 10. That is, the pilot controller 9 establishes connection of the relay 19 during a charging mode of the battery 6 or a working mode of the heater 7. The pilot controller 9 breaks the connection of the relay 19 during a non-charging mode of the battery 6 and a non-working mode of the heater 7. When such a condition is satisfied, the pilot controller 9 establishes the connection of the relay 19. Moreover, the pilot controller 9 converts the information on the current available from the external power source into a pilot signal of a duty ratio corresponding to this information. Then, the pilot controller 9 outputs this pilot signal to the signal line L3.

The on-board controller 1 charges the battery 6 when the charge permission switch 17 is turned on, and allows the heater 7 to work when the warm-up heater switch 18 is turned on. During the charging of the battery 6, the on-board controller 1 controls the charging current, on the basis of the pilot signal carried from the pilot controller 9. In addition, the on-board controller 1 sets the warm-up current supplied to the heater 7, on the basis of the charge current and the current available from the external power source.

### [3-2. Control Block Configuration]

The on-board controller 1 includes a temperature acquisition unit 2, a current detecting unit 3, and a current distribution unit 4, in the form of software or hardware for implementing the above-mentioned control.

The temperature acquisition unit 2 acquires the temperature of the battery 6. For example, the temperature acquisition unit 2 acquires information on a battery temperature T detected by a temperature sensor (not shown) provided in the battery 6. Alternatively, the temperature acquisition unit 2 may estimate the battery temperature T, on the basis of, for example, information on an ambient temperature detected by an ambient temperature sensor (not shown), information regarding the working state of the vehicle 10, and information on the elapsed time since the stop of the vehicle 10. The battery temperature T acquired in this manner is transmitted to the current distribution unit 4.

The current detecting unit 3 detects, as an external current I₀, the current available from the external power source, on the basis of the duty ratio of the pilot signal carried from the pilot controller 9. A current the external power source is allowed to supply depends on the type of the external power source, and also varies depending on other electrical apparatuses connected to the external power source and circuit configurations thereof. In this case, the information on the detected external current I₀ is carried to the current distribution unit 4.

The current distribution unit 4 (current distribution control unit) distributes the external current I₀, which has been supplied from the exterior of the vehicle 10, to a current for charging the battery 6 and a current to be supplied to the heater 7, and controls the both currents. This current distribution unit 4 is provided with a charge control unit 4a and a warm-up control unit 4b: The charge control unit 4a mainly controls charge over the vehicle 10; and the warm-up control unit 4b mainly has warming-up control over the vehicle 10. These charge control unit 4a and warm-up control unit 4b set the respective currents, in order to distribute the external current I₀ to the current for charging the battery 6 and the current to be supplied to the heater 7 appropriately.

The charge control unit 4a controls the charging of the battery 6 when the charge permission switch 17 is turned on. In addition, the charge control unit 4a regulates the DC current into which the on-board charger 8 converts the AC current, thereby controlling the current for charging the battery 6. Thereafter, a current supplied to the on-board charger 8 through the power source lines L4 and L4 is referred to as a “charging current I_{CH}” (or a “battery supply current”).

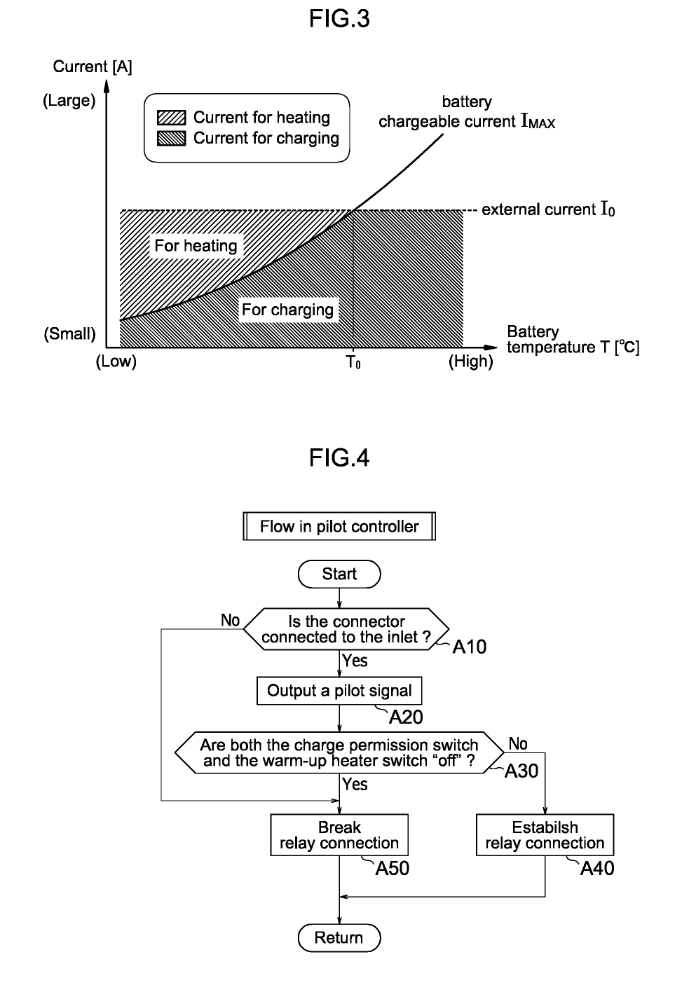

The charge control unit 4a sets, as the charging current I_{CH}, a smaller one between a battery chargeable current I_{MAX} that is determined on the basis of the temperature property of the battery 6, and the external current I₀ that is detected by the current detecting unit 3 (I_{CH}≦I₀ and I_{CH}≦I_{MAX}). This battery chargeable current I_{MAX} is defined as a function of the battery temperature T, for example, as shown by a solid line in FIG. 3. Specifically, the relationship between the battery temperature T and the battery chargeable current I_{MAX} is defined such that the battery chargeable current I_{MAX} decreases, as the battery temperature T decreases.

Moreover, the charge control unit 4a terminates the charge control, when a predetermined charging completion condition is satisfied. Then, the charge control unit 4a outputs a control signal for turning off the charge permission switch 17. It is believed that a specific example of the charging completion condition is that the battery 6 is charged with electricity by a predetermined amount or greater (or the SOC (state of charge) of the battery 6 becomes a predetermined percent or greater), or the elapsed time spent for the charge control reaches or exceeds a predetermined period. Note that the charge control unit 4a also terminates the charge control, when the charge permission switch 17 is turned off manually.

The warm-up control unit 4b performs the warm-up control when the warm-up heater switch 18 is turned on. Specifically, the warm-up control unit 4b controls the amount of the generated heat for warming up by regulating the current supplied to the heater 7. Thereafter, the current which is supplied to the heater 7 through the power source lines L4 and L4 is referred to as a “warm-up current I_{HE}” (or a “heater supply current”).

This warm-up control unit 4b sets, as the warm-up current I_{HE}, a current obtained by subtracting the charging current I_{CH} from the external current I₀ while the battery 6 is being charged (I_{HE}=I₀−I_{CH}). Specifically, the remaining amount that is obtained by subtracting the current for charging from the current supplied from the external power source is allocated to the warm-up current I_{HE}. Meanwhile, the warm-up control unit 4b sets the external current I₀, as the warm-up current I_{HE} as it is, when the battery 6 is not charged.

Moreover, the warm-up control unit 4b terminates the warm-up control, when a predetermined warm-up completion condition is satisfied. Then, the warm-up control unit 4b outputs a control signal for turning off the warm-up heater switch 18. It is believed that a specific example of the warm-up completion condition is that the battery temperature T becomes a predetermined temperature or greater, or the elapsed time spent for the warm-up control reaches or exceeds a predetermined period. Furthermore, the warm-up control can be started or stopped manually, similar to the charge control. Accordingly, the warm-up control unit 4b also terminates the warm-up control, when the warm-up heater switch 18 is turned off manually.

### 4. FLOWCHART

### [4-1. Pilot Controller]

FIG. 4 is a flowchart illustrating control process steps performed by the pilot controller 9. The pilot controller 9 is turned on, immediately after the plug 14 is connected to the electrical outlet 16 of an external power source. Subsequently, the pilot controller 9 repeatedly controls the connection (connecting and disconnecting state) of the relay 19 and the output of a pilot signal at predetermined intervals (for example, at intervals of several microseconds).

At Step A10, the pilot controller 9 determines the connecting state of the connector 12a of the charging gun 12 to the inlet 15 of the vehicle 10. In this embodiment, the connecting state between the vehicle 10 and the charging cable 11 is distinguished on the basis of a signal voltage from the signal voltage detecting line D2. If the connector 12a is connected to the inlet 15 (“Yes” at Step A10), the control process proceeds to Step A20; otherwise (“No” at Step A10), the control process proceeds to Step A50.

At Step A20, the pilot controller 9 generates a pilot signal that has a duty ratio corresponding to a current available from the external power source and, then outputs the generated signal to the signal line L3. For example, the duty ratio corresponds to the RMS (root mean square) of the AC current supplied from the external output source. The pilot signal is always carried to the on-board controller 1 through the signal line L3 during the supply of the electricity.

At Step A30, the pilot controller 9 determines the off state of both the charge permission switch 17 and the warm-up heater switch 18 in the vehicle 10. The operating states of the switches 17 and 18 are also distinguished on the signal voltage carried from detecting line D2. In this case, if both the charge permission switch 17 and the warm-up heater switch 18 are “off” (“Yes” at Step A30), the control process proceeds to Step A50; otherwise, if at least one of the switches 17 and 18 is “on” (“No” at Step A30), the control process proceeds to Step A40.

At Step A40, the pilot controller 9 outputs a control signal to the relay 19 to establish the connection thereof. Consequently, the electricity is supplied from the external power source to both the heater 7 and the on-board charger 8 through the power source lines L1, L1, L4 and L4.

After the control process proceeds to Step A50, the pilot controller 9 outputs a different control signal from that at Step A40 to break the connection of the relay 19. Consequently, the electricity supplied from the electrical outlet 16 is interrupted. For example, if the connector 12a is disconnected from the inlet 15, or if both the charge permission switch 17 and the warm-up heater switch 18 are turned off during the supply of the external electricity, the electricity supplied from the relay 19 to the connector 12a is stopped.

### [4-2. On-Board Controller]

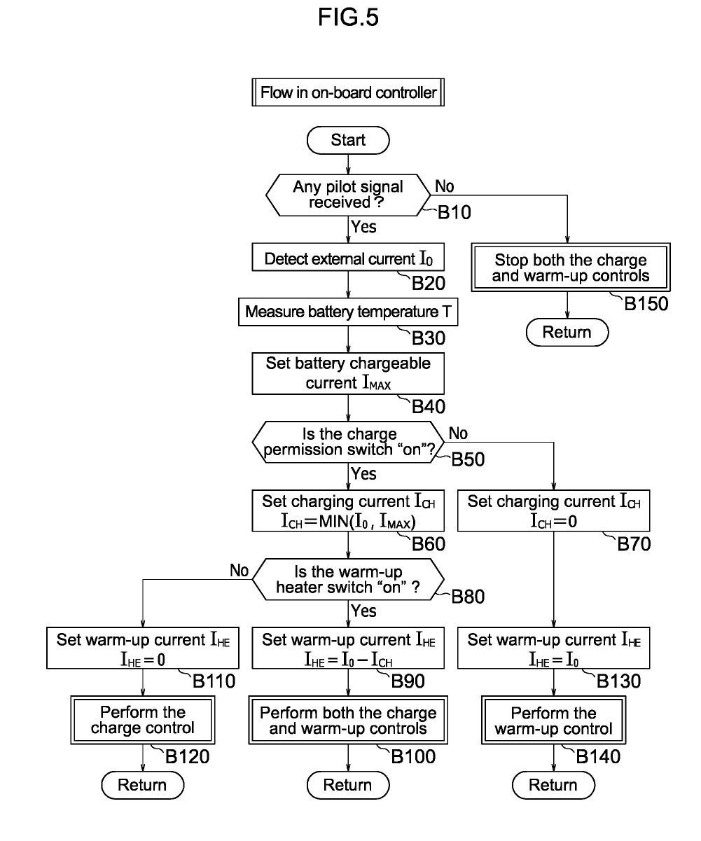

FIG. 5 is a flowchart illustrating control steps performed by the on-board controller 1. The on-board controller 1 runs on electricity supplied from an on-board battery (not shown), and repeatedly controls the operations of the heater 7 and the on board charger 8 at predetermined intervals (for example, at intervals of several microseconds).

At Step B10, the on-board controller 1 determines whether the current detecting unit 3 has received a pilot signal from the pilot controller 9. If the pilot signal has not been received (“No” at Step B10), the control process proceeds to Step B150, and neither of the charge or warm-up control is performed. This is because that any trouble occurs in the external power source, or the connector 12a is disconnected from the inlet 15. If the pilot signal has been received (“Yes” at Step B10), the control process proceeds to Step B20.

At Step B20, the current detecting unit 3 detects an external current I₀, on the basis of the duty ratio of the pilot signal. This external current I₀ corresponds to a maximum current to be supplied to the vehicle 10 from the external power source. At Step B30, the temperature acquisition unit 2 acquires a battery temperature T. The battery temperature T is a parameter for estimating the chargeable capacity of the battery 6.

At Step B40, the charge control unit 4a sets a battery chargeable current Iₘₒ, on the basis of the battery temperature T. At Step B50, the on-board controller 1 then determines the “on” state of the charge permission switch 17. If the charge permission switch 17 is “on” (“Yes” at Step B50), the control process proceeds to Step B60: otherwise, (“No” at Step B50), the control process proceeds to Step B70.

At Step B60, the charge control unit 4a sets a charging current I_{CH}. In this case, the set charging current I_{CH} is a smaller one between the battery chargeable current I_{MAX} and the external current I₀. Then, at Step B80, the on-board controller 1 determines the “on” state of the warm-up heater switch 18. If the warm-up heater switch 18 is “on” (“Yes” at Step B80), the control process proceeds to Step B90; otherwise (“No” at Step B80), the control process proceeds to Step B110.

At Step B90, the warm-up control unit 4b sets a warm-up current I_{HE}. In this case, since both the charge permission switch 17 and the warm-up heater switch 18 are “on”, the warm-up current I_{HE} is obtained by subtracting the charging current I_{CH} from the external current I₀. At Step B100, the on-board controller 1 then performs both the charge and warm-up controls at the same time. Specifically, the charge control unit 4a outputs a control signal to the on-board charger 8, and the charging current I_{CH} is supplied to the on-board charger 8 through the power source lines L4 and L4. Furthermore, the warm-up control unit 4b outputs a control signal to the heater 7, and the warm-up current I_{HE} is supplied to the heater 7 through the power source lines L4 and L4.

If the control process proceeds from Step B80 to Step B110, since the charge permission switch 17 is “on” and the warm-up heater switch 18 is “off”, the on-board controller 1 sets the warm-up current I_{HE} to zero at Step B110 (I_{HE}=0). In this case, only the charge control is performed at Step B120.

If the control process proceeds from Step B50 to Step B70, since the charge permission switch 17 is “off” and the warm-up heater switch 18 is “on”, the on-board controller 1 sets the charging current I_{CH} to zero at Step B70 (I_{CH}=0). The on-board controller 1 then sets the warm-up current I_{HE} to be equal to the external current I₀ at Step B130 (I_{HE}=I₀). In this case, only the warm-up control is performed at Step B140.

### 5. ADVANTAGEOUS EFFECT

The above-described warm-up control device changes the distribution of the external electricity (or the ratio of the charging current I_{CH} to the warm-up current I_{HE}), depending on the battery temperature T, while performing both the charge and warm-up controls at the same time. As shown in FIG. 3, for example, the ratio of the charging current I_{CH} to the warm-up current I_{HE} decreases as the battery temperature T decreases. In other words, the ratio increases as the battery temperature T increases. Specifically, in a charging environment where the battery 6 exhibits a low chargeable capacity, the warm-up control device performs the warm-up control in priority to the charge control. Accordingly, the energy from the external power source is consumed to increase the temperature of the battery 6.

In the graph shown in FIG. 3, the whole external electricity is allocated to the charging at a battery temperature T equal to or more than an intersection temperature T₀ at an intersection between the curve of the battery chargeable current I_{MAX} and the curve of the external current I₀. Specifically, when the temperature of the battery 6 increases to a sufficient level, the warm-up control device performs the charge control in priority to the warm-up control, and the energy from the external power source is stored in the battery 6.

As described above, the warm-up control device increases the warm-up current I_{HE} to be supplied to the heater 7 as the battery temperature T decreases. This can effectively utilize the energy supplied from the external power source for warming up and charging. As a result, the warming-up time is shortened as the ambient temperature decreases. Furthermore, the heater 7 generates a larger amount of heat as the battery temperature T decreases. This adequately improves the charging efficiency of the battery 6 and shortens the charging time, thereby preventing the deterioration of the battery 6.

The warm-up current I_{HE} is set to a value obtained by subtracting the charging current I_{CH} from the external current I₀ during the warm-up control. Thus, the overall current supplied to the vehicle 10 is equal to the external current I₀. This prevents excess current from being supplied from the external power source to the vehicle 10, thus effectively performing the warming-up and charging without actuating a breaker provided in the external power source. Even if the external current I₀ varies, the distribution ratio of the charging current I_{CH} to the warm-up current I_{HE} also varies in response to this variation. This optimizes the charge time and the warm-up time in accordance with the condition of the supply from the external electricity.

Moreover, the relay 19 housed in the control box 13 of the warm-up control device establishes the connection of the power source lines L1 and L1 during the warm-up control operation in addition to the charge control operation. Even after the charging is completed, the heater 7 can still run on the electricity from the external power source. This enables the warming up to be performed while preserving the electricity in the battery 6. If only the charge control is performed, the connection of the power source lines L1 and L1 is cut off immediately after the charging is completed. This saves the external electricity.

The warm-up control device is provided with the warm-up heater switch 18 that operates during the warm-up control, in addition to the charge permission switch 17 that operates during the charge control. The charge permission switch 17 and the warm-up heater switch 18 are connected to the signal line L6 in parallel to each other. This circuit arrangement provides an advantage of ready control of the connection of the power source lines L1 and L1 through operations of the individual switches as necessary. In particular, even if the charging cable 11 is of a known type without a warm-up function, the connection of the relay 19 can be established only during the charging or warming operation.

As described above, the warm-up control device disclosed herein can effectively utilize the energy from the external power source for the charging and warming-up. Therefore, the warm-up control device has great energy saving performance.

### 6. VARIATIONS

Regarding setting of the current for charging or worming up in the embodiment described above, a smaller one between the battery chargeable current I_{MAX} and the external current I₀ is set as the charging current I_{CH}. The setting of the charging current I_{CH} is however not limited to this manner. The minimum requirement is that a smaller one between the battery chargeable current I_{MAX} and the external current I₀ is set as a maximum limit of the charging current I_{CH}.

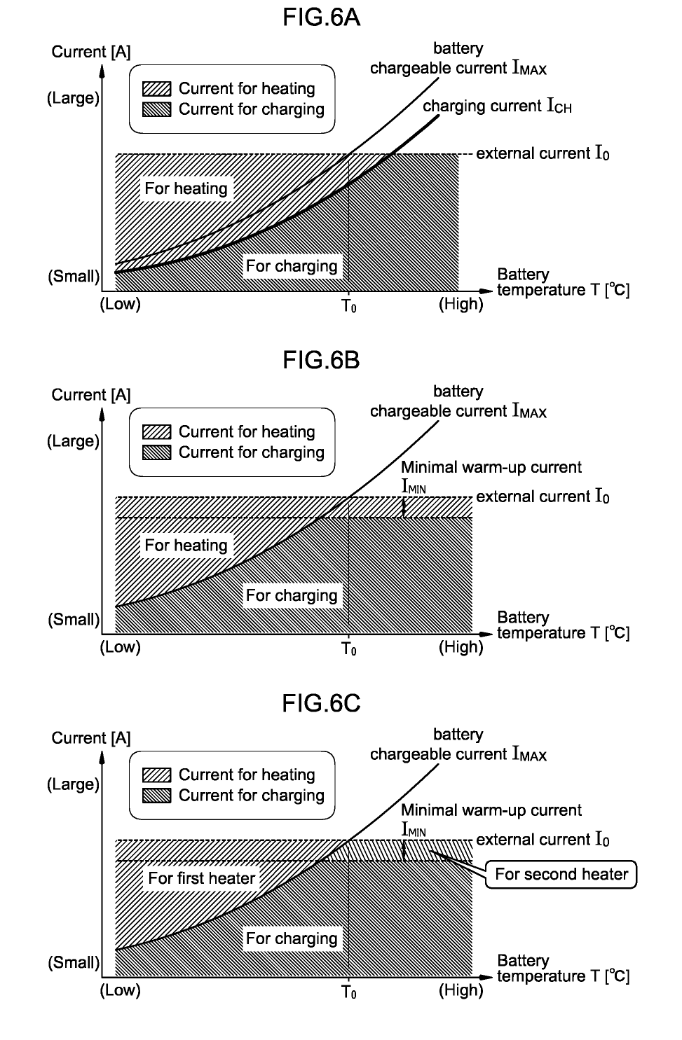

As indicated by a heavy-line curve in FIG. 6A, for example, the relationship between the charging current I_{CH} and the battery temperature T may be determined such that the charging current I_{CH} is smaller than the battery chargeable current I_{MAX} at any battery temperature T. In this case, as the battery temperature T decreases, the warm-up control device further concentrates on the warm-up control in comparison with the above-described embodiment, thereby recovering the chargeable capacity of the battery 6 quickly. This further shortens the charge time, thereby more effectively preventing the deterioration of the battery 6.

In the above-described embodiment, the warm-up control device controls the whole external electricity to be allocated to the charging at battery temperature T equal to or more than the temperature T₀. Alternatively, the warm-up control may always be performed during the charge control. As shown in FIG. 6B, for example, the minimum of the warm-up current I_{HE} may be set as a minimal warm-up current I_{MIN} (I_{HE}=I_{MIN}).

In this case, a smaller one is set as the charging current I_{CH}, between the battery chargeable current I_{MAX} and a predetermined upper limit current I_{CAP} that is obtained by subtracting the minimal warm-up current I_{MIN} from the external current I₀ (if I_{CAP}=I₀−I_{MIN}, then I_{CH}≦I_{CAP} and I_{CH}≦I_{MAX}. As described above, the charge current is set to be lower than the battery chargeable current I_{MAX}. Accordingly, the warm-up control device can preserve the minimal warm-up current I_{MIN} and continue the warm-up control, even after the battery temperature T reaches or exceeds the temperature T₀. This setting is preferable, especially when the warm-up control device performs the charge and warm-up controls in an extremely cold area.

The above-described embodiment exemplifies the electric vehicle that is equipped with the heater 7 for increasing the temperature of the battery 6. However, the heat generated by the heater 7 can be supplied to any component other than the battery 6. Specifically, a plug-in hybrid vehicle equipped with another engine in addition to an electric motor may be provided with a first heater for warming the electric motor and a battery for running, and a second heater for warming the engine, engine oil, cooling water for the engine, and other components. In this case, the warm-up control device may regulate individual currents such that the sum of the currents supplied to the first and second heaters is equal to the warm-up current I_{HE}.

Alternatively, the warm-up control device may regulate the individual currents supplied to the first and second heaters in accordance with the battery temperature T. As shown in FIG. 6C, for example, at a relatively low battery temperature T, the warm-up control device allows the first heater to work in priority to the second heater, in order to increase the temperature of the battery quickly. In contrast, at a relatively high battery temperature T, the warm-up control device determines that the battery is sufficiently warmed, and thus, allows the second heater to work in priority to the first heater, in order to warm the engine.

As described above, the warm-up control device regulates the currents supplied to the heaters in accordance with the battery temperature T, thereby increasing the temperature of the engine while improving the charging efficiency of the battery. This significantly improves on the start-up performance of a hybrid vehicle.

### REFERENCE SIGNS LIST

1 on-board controller
2 temperature acquisition unit
3 current detecting unit
4 current distribution unit (current distribution control unit)
4a charge control unit
4b warm-up control unit
6 battery
7 heater
8 on-board charger
9 pilot controller (relay control unit)
17 charge permission switch
18 warm-up heater switch
19 relay
L3 and L6 signal lines

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A warm-up control device for a vehicle, comprising:
a battery supplying electricity to a motor that drives a vehicle, the battery being capable of being charged with a current supplied from an exterior of the vehicle;
a heater generating heat by the current supplied from the exterior of the vehicle, the heat warming up the vehicle;
a temperature acquisition unit acquiring a temperature of the battery; and
a current distribution control unit distributing the current supplied from the exterior of the vehicle to the battery and the heater,
wherein the current distribution control unit increases a heater supply current supplied to the heater as the temperature of the battery decreases.

2. The warm-up control device for a vehicle according to claim 1,
wherein the current distribution control unit sets a battery supply current supplied to the battery, to be equal to or less than a battery chargeable current determined on the basis of the temperature property of the battery.

3. The warm-up control device for a vehicle according to claim 2, further comprising:
a current detecting unit that detects an external current supplied from the exterior of the vehicle,
wherein the current distribution control unit sets the battery supply current supplied to the battery to be equal to or less than the external current, and sets the maximum heater supply current to a difference between the battery supply current and the external current.

4. The warm-up control device according to claim 2,
wherein the current distribution control unit sets the battery supply current supplied to the battery to be equal to or lower than an upper limit current that is smaller than the external current, so as to maintain the heater supply current.

5. The warm-up control device for a vehicle according to claim 4,
wherein the current distribution control unit sets a value obtained by subtracting a minimal warm-up current from the external current to the upper limit current, the minimal warm-up current corresponding to the minimum heater supply current.

6. The warm-up control device for a vehicle according to claim 3,
wherein the vehicle is a hybrid vehicle equipped with the motor and an engine,
wherein the heater includes a first heater increasing a temperature of the battery, and a second heater increasing the temperature of the engine, and
a wherein the current distribution control unit regulates respective currents supplied to the first heater and the second heater, on the basis of the temperature of the battery.

7. The warm-up control device for a vehicle according to claim 1, further comprising:
a relay disposed on an electricity supply line connecting the vehicle and an external current source that supplies the current to the vehicle; and
a relay control unit establishing connection of the relay during a charging mode of the battery or a working mode of the heater, and breaking the connection of the relay during a non-charging mode of the battery and a non-working mode of the heater.

8. The warm-up control device for a vehicle according to claim 7, further comprising:
signal lines connected to the relay control unit and carrying a current signal indicating a current obtained from the electricity supplied from the exterior of the vehicle;
a charge permission switch connected to the signal lines and providing, to the relay control unit, a signal indicating the charge of the battery, in accordance with an operation of the charge permission switch; and
a warm-up heater switch connected to the signal lines in parallel to the charge permission switch and providing, to the relay control unit, a signal indicating the supply of the electricity to the heater.
